(19) United States
(12) Patent Application Publication
(10) Pub. No.: US 2011/0321018 A1
(43) Pub. Date: Dec. 29, 2011

(54) PROGRAM, METHOD, AND SYSTEM FOR CODE CONVERSION

(75) Inventor: Michiaki Tatsubori, Kanagawa (JP)

(73) Assignee: INTERNATIONAL BUSINESS MACHINES CORPORATION, Armonk, NY (US)

(21) Appl. No.: 13/160,796

(22) Filed: Jun. 15, 2011

(30) Foreign Application Priority Data
Jun. 29, 2010 (JP) 2010-148295

(51) Int. Cl. G06F 9/45

(52) U.S. Cl. 717/137

(57) ABSTRACT

A program product, a method and a system for enhancing the readability of Java® source code obtained by decompiling Java® bytecode. Code which does not directly correspond to language of a second programming language and which is intended to execute an instruction related to a stack operation, is replaced with any combination of an expression for assignment to a temporary variable, a call for a dummy method which only returns part of an argument as-is, and an expression for reading the temporary variable. Code for calling a method which does not correspond to a second programming language and which leaves its value on the stack and has no return value is replaced by a new method. The new method, having an additional first argument and the original argument, executes the original method call and returns the additional first argument as-is.

### CROSS-REFERENCE TO RELATED APPLICATIONS

This application claims priority under 35 U.S.C. §119 to Japanese Patent Application No. 2010-148295 filed Jun. 29, 2010, the entire contents of which are incorporated herein by reference.

### BACKGROUND OF THE INVENTION

1. Field of the Invention

The present invention relates to a program, method, and system for converting code so that executable bytecode generated by a first programming language corresponds to source code written in a second language. More specifically, the invention enhances readability of source code decompiled from bytecode by reducing the number of temporary local variables.

2. Description of Related Art

Jerome Miecznikowski and Laurie Hendren, “Decompiling Java Bytecode: Problems, Traps and Pitfalls,” in Procs. of CC 2002, LNCS 2304, Springer-Verlag, 2002, pp. 111-127 discloses a technology that can aggressively decompile Java® bytecode, which is not necessarily generated using a genuine Java® compiler, by subjecting the bytecode to code conversion.

The aggressive decompiling technology described in the above-mentioned Non Patent Literature can decompile Java® bytecode generated by various processors. Unfortunately, many temporary local variables are inserted during code conversion and, therefore, when the converted Java® bytecode is decompiled into Java® source code, the presence of these many temporary local variables reduces the readability of the source code.

For example, see the following bytecode sequence (<exprX> refers to a partial bytecode sequence corresponding to a Java® expression).

<expr0>
<expr1>
<expr2>
<expr3>
swap
invokestatic C.foo3 (P,P)
invokevirtual P.foo2 (P)
invokevirtual P.foo1 (P)
areturn

The following is source code obtained by decompiling the bytecode strings using the aggressive decompiling technology described in the above-mentioned Non Patent Literature (<exprX> refers to a Java® expression).

C tmp0 = <expr0>;
P tmp1 = <expr1>;
P tmp2 = <expr2>;
return tmp0.foo1(tmp1.foo2(C.foo3(<expr3>,tmp2)));

As seen, many temporary variables appear.

### SUMMARY OF THE INVENTION

According to the present invention, a program product, method and system are provided which allows Java® bytecode to be subjected to the following conversion by a code converter before decompiled by a Java® decompiler. That is, when the code converter finds, in Java® bytecode, code not directly corresponding to any Java® language element and intended to execute an instruction related to a stack operation, the code converter replaces the found code with any combination of an expression for assignment to a temporary variable, a call for a dummy method which only returns part of an argument as-is, and an expression for reading the temporary variable.

When the code converter finds code which does not directly correspond to any language element of Java® and which is intended to call a method which leaves its value on the stack and has no return value, the code converter generates a new method, the new method having an additional first argument and the original argument, executing the original method call, and returning the additional first argument as-is, and replaces the method having no return value with a call for the new method.

An advantage of converting bytecode as described above is reducing the number of temporary variables generated when decompiling the bytecode into source code according to the related art, thereby enhancing the readability of the source code. Specifically, the above-mentioned bytecode is decompiled into the following source code:

P tmp;
return <expr0>.foo1(<expr1>.foo2(C.foo3(DBF.swap
(tmp=<expr2>,<expr3>),tmp)));

Such a code converter can be disposed in a stage preceding an ordinary Java® bytecode decompiler or incorporated into a Java® bytecode decompiler as part of the processing logic.

The present invention is applicable to decompilation of Java® bytecode, as well as to a code conversion process serving as part of a code generation process so that an ordinary decompiler can decompile bytecode including an instruction related to a stack operation and generated by any language processor for generating intermediate code for an implementation.

A further advantage of the present invention is enhanced readability of the decompiled source code when an instruction, which the target language processor does not directly support, is replaced with code for calling a predetermined method.

### BRIEF DESCRIPTION OF THE DRAWINGS

FIG. 1 illustrates a schematic hardware block diagram according to an embodiment of the present invention.

FIG. 2 illustrates a software hierarchy according to an embodiment of the present invention.

FIG. 3 illustrates a function logic block diagram according to an embodiment of the present invention.

FIG. 4 illustrates a flowchart of a process performed by a code converter according to an embodiment of the present invention.

### DETAILED DESCRIPTION OF THE PREFERRED EMBODIMENTS

Dynamic scripting languages such as PHP and more static programming languages such as Java® have been used as a programming language processor or programming language implementation for use in the server environment. On the other hand, in order to call Java® class resources from PHP or the like in a simplified manner, a mechanism has been provided in recent years where, on a static language platform such as the Java® Virtual Machine or the Common Language Infrastructure (CLI), a dynamic scripting language such as PHP declares a class of the static language platform to allow untyped access.

In particular, P8, JRuby, and Jython are known as implementations of PHP, Ruby, and Python, respectively, which run on the Java® Virtual Machine. These dynamic scripting languages that run on the Java® Virtual Machine generate Java® bytecode as a matter of course. On the other hand, Java® experts may need to decompile the generated Java® bytecode into Java® source code for performance tuning and other purposes.

While javap, which comes standard with JDK, only disassembles Java® bytecode, SourceAgain, JAD, JODE, and the like are known as tools for decompiling Java® bytecode into Java® source code.

For Java® bytecode generated using javac or the like from source code written using Java®, it is not difficult to decompile the bytecode into Java® source code using the above-mentioned decompiling tools, unless the bytecode is extremely obfuscated.

However, dynamic scripting language processors, such as P8, JRuby, and Jython, have language specifications different from Java®, which is essentially a static language processor. For this reason, Java® bytecode generated by these implementations may contain bytecode operators that Java® does not originally have, such as swap.

Accordingly, attempts to decompile Java® bytecode generated by these dynamic scripting language processors using ordinary decompiling tools disadvantageously fail to obtain Java® source code.

An object of the present invention is to enhance the readability of Java® source code obtained by decompiling Java® bytecode generated by non-Java®-native processors, such as dynamic scripting language processors which run on the Java® Virtual Machine.

An embodiment of the present invention will be described with reference to the accompanying drawings. It should be understood that this embodiment is intended to describe a preferred aspect of the present invention and that there is no intent to limit the scope of the invention to the embodiment. Same reference signs designate same components through the drawings below unless otherwise specified.

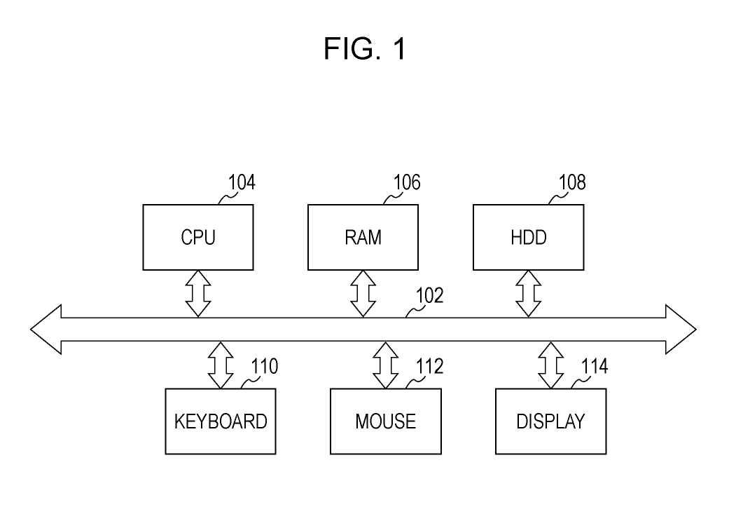

FIG. 1 shows a block diagram of computer hardware for realizing a system configuration and processes according to this embodiment. In FIG. 1, a CPU 104, a main memory (RAM) 106, a hard disk drive (HDD) 108, a keyboard 110, a mouse 112, and a display 114 are connected to a system bus 102. The CPU104 is preferably based on a 32-bit or 64-bit architecture and can be, for example, Pentium™ 4 available from Intel Corporation, Core™ 2 DUO available from Intel Corporation, or Athlon™ available from Advanced Micro Devices, Inc. The capacity of the main memory 106 is preferably not less than 1 GB and more preferably not less than 2 GB.

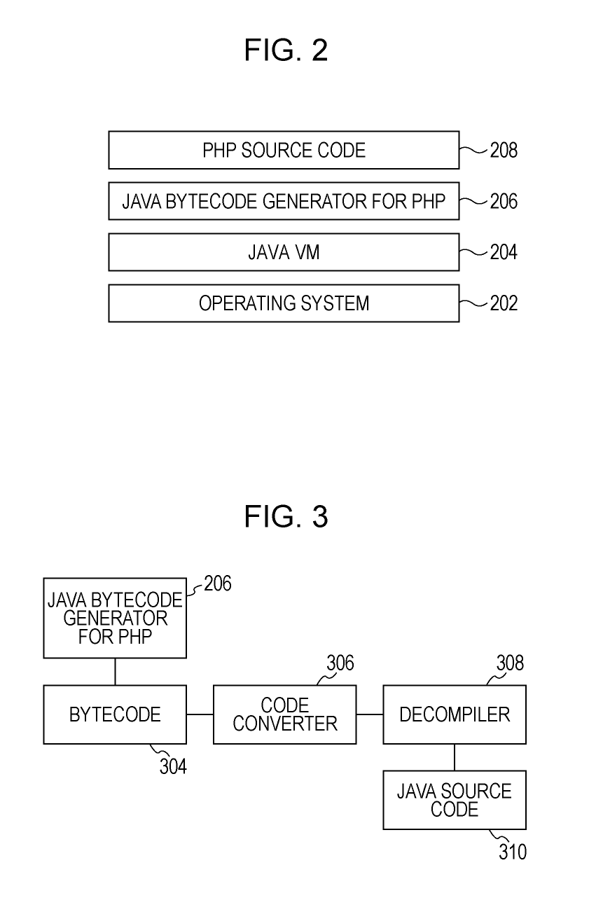

An operating system 202 (to be described in FIG. 2) is installed on the hard disk drive 108. The operating system 202 can be any type of operating system conforming to the CPU 104, such as Linux™, Windows™ 7, Windows XP™, or Windows™ 2003 server available from Microsoft Corporation, or Mac OS™ available from Apple Inc. Upon start-up, the operating system 202 is loaded into the main memory 106 to run.

A Java® Runtime Environment program for realizing a Java® Virtual Machine (VM) 204 (to be described in FIG. 2) is also installed on the hard disk drive 108. Upon start-up of the system, it is loaded into the main memory 106 to run.

Also installed on the hard disk drive 108 are a Java® bytecode generator 206 for PHP (to be described in FIG. 2), which is typically P8, source code 208 (to be described in FIG. 2) written using PHP, a code converter 306 (to be described in FIG. 3) having functions unique to the present invention, and a decompiler 308 (to be described in FIG. 3). While the code converter 306 and the decompiler 308 can be written using any computer language such as C or C++, it is preferable that they be written using Java® and run on the Java® Virtual Machine 204.

FIG. 2 is a diagram showing the software hierarchy. The Java® Virtual Machine 204 runs on the lowest-layered operating system 202. The Java® bytecode generator 206 for PHP runs on the Java® Virtual Machine 204. The Java® bytecode generator 206 for PHP converts the PHP source code 208 into Java® bytecode interpretable by the Java® Virtual Machine 204. The PHP source code 208 is a file whose extension is php and where a statement defined by a PHP language specification is written in a location specified by <?php . . . ?>.

FIG. 3 is a function logic block diagram. In FIG. 3, the Java® bytecode generator 206 for PHP converts the PHP source code 208 into Java® bytecode 304, as described above. The converted Java® bytecode 304 can be loaded into the main memory 106 or saved into the hard disk drive 108.

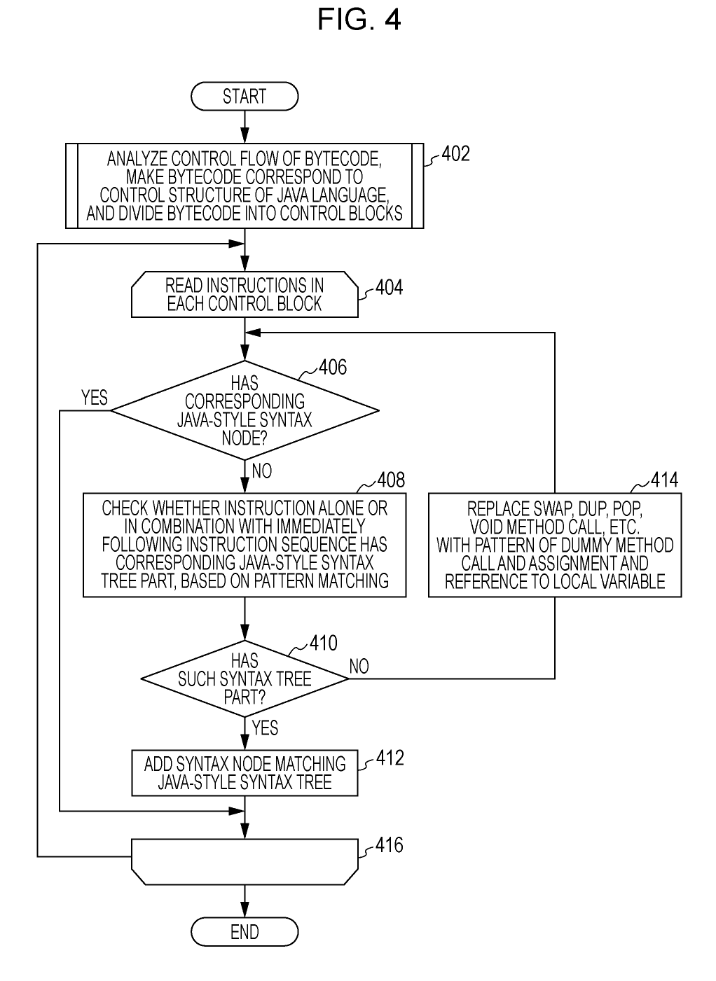

The code converter 306 has the function of converting the Java® bytecode 304 before passing it to a decompiler 308 so as to perform the functions of the present invention. The functions of the code converter 306 will be described in detail later with reference to a flowchart of FIG. 4. The decompiler 308 can be any known decompiler such as SourceAgain, JAD, or JODE. Alternatively, the decompiler 308 can have the functions of the code converter 306 as preprocessing. This eliminates the need for the code converter 306 as a separate program, making the decompiler 308 itself a unique decompiler having the functions of the present invention.

Alternatively, the Java® bytecode generator 206 for PHP can have the functions of the code converter 306 as postprocessing. This also eliminates the need for the code converter 306 as a separate program, making the Java® bytecode generator 206 for PHP itself a unique bytecode generator having the functions of the present invention.

Next, referring to the flowchart of FIG. 4, processes performed by the code converter 306 will be described. First, in step 402, the code converter 306 performs a process for analyzing the control flow of the Java® bytecode 304, making the bytecode correspond to the control structure of the Java® language, and dividing the bytecode into control blocks. This process is performed using, e.g., a method described in Fuyuhiko Maruyama, Hirotaka Ogawa, and Satoshi Matsuoka, “An Effective Decompilation Algorithm for Java Bytecodes,” Transactions of Information Processing Society of Japan, Vol. 41, No. 2, February 2000, http://ci.nii.ac.jp/Detail/detail.do?LOCALID=ART0003013366.

Next, in step 404, a process for sequentially reading instructions in each control block is performed. This process is performed as a loop from step 404 to step 416.

In step 406, the code converter 306 determines whether the target instruction has a corresponding Java®-style syntax node. If the instruction does, there remains nothing to do in the process. The code converter 306 returns from step 416 to step 404 to handle the next instruction.

If the code converter 306 determines in step 406 that the target instruction is not supported as a Java®-style syntax node, it proceeds to step 408 and checks whether the instruction alone or in combination with the immediately following instruction can be supported as part of a Java® syntax tree, based on whether patterns are matched.

If the code converter 306 determines in step 410 that the instruction can be supported as part of a Java® syntax tree, it proceeds to step 412 and adds a syntax node matching the Java® syntax tree. The code converter 306 then returns from step 416 and goes to step 404 to handle the next instruction.

In contrast, if the code converter 306 determines in step 410 that the instruction cannot be supported as part of a Java® syntax tree, it proceeds to step 414. Step 414 includes a process unique to the present invention.

In step 414, the code converter 306 performs a process for replacing an instruction which is among instructions such as swap, dup, pop, and a void method call and which, due to the stack situation, does not directly correspond to any Java® language element even when combined with different bytecode, with a combination pattern of a dummy method call and assignment and reference to a local variable, or a combination pattern of a dummy method call and an extracted method call.

Specifically, the code converter 306 previously holds a rule for replacing instructions not directly corresponding to any Java® language element and applies the rule in step 414.

The code converter 306 then returns to step 406 and determines whether the replaced instruction has a corresponding Java®-style syntax node.

When processing all the instructions in this way, the code converter 306 exits from the loop from step 404 to step 416 to complete the process.

To facilitate the understanding of the present invention, the above-mentioned instruction replacement rule in step 414 will be described in more detail.

In the process of step 414, code that cannot be represented by a straight-forward program in the Java® language is divided into two types.

(1) Code which does not directly correspond to any Java® language element and which is intended to execute an instruction related to a stack operation.

(2) Code which does not directly correspond to any Java® language element and is intended to call a method which leaves its value on the stack and has no return value.

Typical examples of the code of (1) are swap, dup, and pop. For the meanings and functions of these instructions in Java® bytecode, see documents such as Java Virtual Machine Specification Second Edition by Tim Lindholm and Frank Yellin, 1999 Sun Microsystems, Inc.

In this case, a class as shown below is generated:

class DFB {

static <T> T swap (Object placeholder, T preservation) {

return preservation;

}
static <T> T dup (T preservation) {

return preservation;

}
static <T> T pop (T preservation, Object erasure) {

return preservation;

}

}

Using the class DFB described above, rules for converting swap, dup, and pop will be described.

First, assume that there is the following bytecode including swap.

...
<expr0>
<expr1>
<expr2>
swap
...

This bytecode is converted as follows in step 414 of FIG. 4.

...
<expr0>
<expr1>
dup
astore'tmp
<expr2>
invokestatic DFB.swap(Object,T):T
aload'tmp
...

Assume that there is the following bytecode including dup.

...
<expr0>
<expr1>
dup
...

This bytecode is converted as follows in step 414 of FIG. 4.

...
<expr0>
<expr1>
dup
astore'tmp
invokestatic DFB.dup(T):T
aload'tmp
...

Assume that there is the following bytecode including pop.

...
<expr0>
<expr1>
pop
...

This bytecode is converted as follows in step 414 of FIG. 4.

...
<expr0>
<expr1>
invokestatic DFB.pop(T,Object):T
...

The code of (2), meaning code not directly corresponding to any Java® language element and intended to call a method which leaves its value on the stack and has no return value, can be the following exemplary bytecode:

<expr1>
<expr2>
<expr3>
aload1//runtime
invoke checkTimer(Runtime):void
invoke compare(P,P):P

Here, first, the code converter 306 generates the following code.

private static <T> T call_checkTimer (T preservation, Runtime arg1) {
Op.checkTimer (arg1);//original call
return preservation;
}

It then performs the following conversion:

<expr1>
<expr2>
<expr3>
aload1//runtime
invoke <T>call_checkTimer(T,Runtime):T
invoke compare(P,P):P

In the resulting source code, <expr3> is incorporated into a call expression, call_checkTimer ( ), as an argument to eliminate the need to assign temporary variables to <expr1> and <expr2>. Thus, no temporary variable appears.

A more complicate case of the code of (1), meaning code not directly corresponding to any Java® language element and intended to execute an instruction related to a stack operation, will be described. The following are all stack operators covered by the Java® VM:

pop, pop2, dup, dup_x1, dup_x2, dup2, dup2_x1, dup2_x2, swap

Of these stack operators, pop, dup, and swap have already been described, so the others will now be described.

In this case, the following class is generated:

class DFB {

static <T> T pop2 (T pr,Object er1,Object er2) {

return pr;

}
static <T> T dup2 (T preservation, Object placeholder) {

return preservation;

}
static <T> dup_x1 (T preservation, Object placeholder) {

return preservation;

}
static <T> dup2_x2 (T pr, Object ph2, Object ph3, Object ph4) {

return pr;

}

}

Although omitted in this class, a pop method, dup method, or swap method can be written, and details thereof have been described. Multiple examples of conversion using such a class are shown below.

Where the original code is <e0><e1><e2>pop2, conversion is performed as follows:

<e0><e1><e2>DBF.pop2

Where the original code is <e0><e1><e2>dup2, conversion is performed as follows:

<e0><e1>dup tmp1=<e2>dup tmp2=DBF.dup2( )=tmp2=tmp1=tmp2

Alternatively, conversion can be performed as follows:

<e0> <e1> dup tmp1= <e2> DBF.dup2_1 ( ) <e2> dup tmp2=
DBF.dup2_2 ( ) =tmp1 =tmp2 =tmp1 =tmp2

The reason why there can be multiple patterns as described above is that if where the stack operation is complicate, there are variations in the way a dummy method is inserted. Accordingly, one of the variations is implemented.

Where the original code is <e0><e1><e2>dup_x1, conversion is performed as follows:

<e0><e1>dup tmp1=<e2>dup tmp2=DBF.dup_x1 ( )=tmp2=tmp1

Alternatively, conversion can be performed as follows:

<e0> <e1> dup tmp1= DBF.dupx1_1 ( ) <e2> dup tmp2=
DBF.dupx1_2 ( ) =tmp1 =tmp2 =tmp1

Where the original code is <e0><e1><e2>dup_x2, conversion is performed as follows:

<e0> <e1> dup tmp1= <e2> dup tmp2= <e3> dup tmp3= <e4> dup
tmp4= DBF.dup2_x2 ( ) = tmp2 =tmp3 =tmp4 =tmp1 =tmp2

Alternatively, conversion can be performed as follows:

<e0> <e1> dup tmp1= DBF.dupx2_x2_1 ( ) <e2> dup tmp2= ..
<e3> dup tmp3= .. <e4>
dup tmp4= .. =tmp1 =tmp2 =tmp3 =tmp4 =tmp1 =tmp2

The following code is decompiled using a traditional technique as described in Non Patent Literature 1.

<expr0>
<expr1>
<expr2>
<expr3>
swap
invokestatic C.foo3 (P,P)
invokevirtual P.foo2 (P)
invokevirtual P.foo1 (P)
areturn

As seen in the decompilation result below, many temporary variables remain.

C tmp0 = <expr0>;
P tmp1 = <expr1>;
P tmp2 = <expr2>;
return tmp0.foo1(tmp1.foo2(C.foo3(<expr3>,tmp2)));

According to the present invention, on the other hand, the following part of the original bytecode:

<expr1>
<expr2>
<expr3>
Swap

is converted into:

<expr1>
<expr2>
dup
astore'tmp
<expr3>
invokestatic DFB.swap(Object,T):T
aload'tmp

Thus, as seen below, code having a reduced number of temporary variables and high readability is obtained as the decompiled source code.

P tmp;
return <expr0>.foo1(<expr1>.foo2(C.foo3(DBF.swap
(tmp=<expr2>,<expr3>),tmp)));

While the bytecode generated by the bytecode generator for PHP is converted in the above-mentioned embodiment, the present invention is applicable to Java® bytecode generated by any programming language processor for generating Java® bytecode, such as JRuby or Jython.

Further, it will be understood by those skilled in the art that the present invention is applicable to Java® bytecode as well as to intermediate code generated by any language processor and including code which does not correspond to the target language and which is related to a stack operation or calls a method which leaves its value on the stack and has no return value.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. An article of manufacture tangibly embodying computer readable instructions which, when implemented, cause a computer to carry out the steps of a method of converting a code so that an executable bytecode generated by a processor for a first programming language corresponds to source code written in a second programming language, the steps of the method comprising:
sequentially reading instructions in the executable bytecode generated by the processor for the first programming language;
when a first code is found which does not directly correspond to any language element of the second programming language and which is intended to execute an instruction related to a stack operation, replacing the first found code with any combination of an expression for assignment to a temporary variable, a call for a dummy method which only returns part of an argument as-is, and an expression for reading the temporary variable; and
when a second code is found which does not directly correspond to any language element of the second programming language and which is intended to call an original method which leaves a value thereof on a stack and has no return value, generating a new method which has an additional first argument and an original argument, wherein the new method executes the original method call, and returns the additional first argument as-is, and replacing the call for the original method having no return value with a call for the new method.

2. The article of manufacture according to claim 1, further comprising the step of preprocessing so as not to introduce excess temporary variables.

3. The article of manufacture according to claim 1, further comprising the step of postprocessing so as to generate bytecode which can be easily decompiled by a decompiler which does not introduce temporary variables.

4. The code conversion program product according to claim 1, wherein
the first programming language is a PHP language, and
the second programming language is Java.

5. A code conversion method of converting code using a computer so that executable bytecode generated by a processor for a first programming language corresponds to source code written in a second programming language, the method comprising the steps of:
sequentially reading instructions in the executable bytecode generated by the processor for the first programming language by using the computer;
when a first code is found which does not directly correspond to any language element of the second programming language and which is intended to execute an instruction related to a stack operation, replacing the first found code with any combination of an expression for assignment to a temporary variable, a call for a dummy method which only returns part of an argument as-is, and an expression for reading the temporary variable by using the computer; and
when a second code is found which does not directly correspond to any language element of the second programming language and which is intended to call an original method which leaves a value thereof on a stack and has no return value, generating a new method which has an additional first argument and an original argument, wherein the new method executes the original method call, and returns the additional first argument as-is and replacing the call for the original method having no return value with a call for the new method by using the computer.

6. The code conversion method according to claim 5, wherein
the first programming language is a PHP language, and
the second programming language is Java.

7. A computer implemented code conversion system for converting code so that executable bytecode generated by a processor for a first programming language corresponds to source code written in a second programming language, the system comprising:
means that sequentially reads instructions in the executable bytecode generated by the processor for the first programming language;
means that, when finding a first code which does not directly correspond to any language element of the second programming language and which is intended to execute an instruction related to a stack operation, replaces the first found code with any combination of an expression for assignment to a temporary variable, a call for a dummy method which only returns part of an argument as-is, and an expression for reading the temporary variable; and
means that, when finding a second code which does not directly correspond to any language element of the second programming language and which is intended to call an original method which leaves a value thereof on a stack and has no return value, generates a new method, the new method having an additional first argument and an original argument, executing the original method call, and returning the additional first argument as-is, and replaces the call for the original method having no return value with a call for the new method.

8. The code conversion system according to claim 7, wherein
the first programming language is a PHP language, and
the second programming language is Java.
